(19) United States
(12) Patent Application Publication
(10) Pub. No.: US 2004/0026990 A1
(43) Pub. Date: Feb. 12, 2004

(54) Regulation of the brake pressure in the event of steep pressure buildup gradients

(76) Inventors: Alexander Haeussler, Kornwestheim (DE); Heiner Messner, Kornwestheim (DE)

Correspondence Address: KENYON & KENYON, ONE BROADWAY, NEW YORK, NY, 10004, US

(21) Appl. No.: 10/400,779

(22) Filed: Mar. 26, 2003

(30) Foreign Application Priority Data
Mar. 26, 2002 (DE) 102 13 388.3
Aug. 21, 2002 (DE) 102 38 217.4

(51) Int. Cl. B60T 8/34

(52) U.S. Cl. 303/113.1

(57) ABSTRACT

A method and a device are described for controlling the brake pressure acting on a wheel brake in a braking system having a pressure generation device for generating a setpoint pressure (Pset) preset by a regulation, an intake valve for admitting a brake fluid into the wheel brake, and a pressure-limiting valve for limiting the brake pressure to a selectable threshold value. To improve the braking response of the wheel brake, it is suggested that the threshold value be set at the pressure-limiting valve as a function of the pressure buildup gradient.

### FIELD OF THE INVENTION

The present invention relates to a method of controlling the brake pressure acting on a wheel brake and a braking system.

### BACKGROUND INFORMATION

When starting off and accelerating a vehicle on a slippery road surface, the driven wheels may slip greatly if even a slight drive torque is applied, or the vehicle may skid during dynamic curve travel. In the scope of TCS or ESP regulation, the corresponding wheels are automatically braked in order to improve the traction of the vehicle and ensure the stability of the vehicle. In this case, the brake pressure in the wheel brake is automatically set to a preset setpoint value at the request of the TCS or ESP.

FIG. 1 shows a schematic illustration of a braking system for the four wheels 8 of a vehicle.

In the event of a braking action, during which the driver actively operates brake pedal 1, brakes 9 of wheels 8 have pressure applied to them in accordance with the braking force applied by the driver. A brake fluid is conducted from brake master cylinder 10 to brakes 9 of vehicle wheels 8 via hydraulic lines 7, a high-pressure-resistant switching valve 2, and intake valves 5.

During a braking intervention caused by a regulation, the brake pressure is generated by a hydraulic pump 4, which is appropriately activated by the regulator. During a pump cycle, a brake fluid is first suctioned via high-pressure-resistant switching valve 2 and subsequently applied to brake 9 with pressure through expelling the piston. After a pressure buildup phase, which lasts multiple pump cycles, a (quasi) stationary brake pressure is finally reached at wheel brakes 9. In this case, brake pressure and the pressure buildup gradient, i.e., the gradient with which the brake pressure increases, are preset by the regulation as appropriate setpoint values.

In the event of a low pressure buildup gradient, the brake pressure prevailing in brakes 9 follows the setpoint pressure with a relatively small time delay.

However, in the event of a rapid dynamic pressure buildup, i.e., in the event of a steep pressure buildup gradient, the brake pressure in wheel brakes 9 is only reached after a significant time delay. This is because, in the event of high dynamic pressure buildup, a stagnation pressure results at intake valves 5, which may significantly exceed the desired setpoint pressure (e.g., 20 bar). If the pressure in the braking system exceeds the desired stationary setpoint value, a pressure-limiting valve 3, which is set to the appropriate setpoint value, overflows and reduces the pressure in the brake circuit. This leads to an unintended volume loss via pressure-limiting valve 3 in a pressure buildup phase, in which the brake pressure at brake 9 of wheel 8 has not yet reached the desired setpoint value.

### SUMMARY OF THE INVENTION

It is therefore an object of the present invention to improve the braking response of the wheel brakes in the event of steep pressure buildup gradients.

What the present invention accomplishes is to set the threshold value of a pressure-limiting valve, using which the maximum pressure in the brake circuit of a braking system is set, as a function of the pressure buildup gradient. In this way, the pressure-limiting valve does not overflow in the event of short-term pressure increases in the brake circuit and the brake pressure acting in the wheel brake builds up more rapidly.

According to a preferred embodiment of the present invention, a higher threshold value is set at the pressure-limiting valve with an increasing pressure buildup gradient. In other words, for steeper pressure buildup gradients, a threshold value is set which is comparatively higher than for an identical setpoint pressure and flatter pressure buildup gradients. The threshold value may be increased continuously or step-by-step.

The threshold value is preferably increased on the basis of characteristic curves or tables which are stored in the regulation system.

### BRIEF DESCRIPTION OF THE DRAWINGS

FIG. 1 shows a schematic illustration of a braking system.

FIG. 2 shows a setpoint pressure curve having multiple dynamic pressure increases.

FIG. 3 shows the current curve in a pressure-limiting valve with and without increasing the threshold value.

FIG. 4 shows a flow chart to illustrate the method steps when setting the setpoint pressure at the pressure-limiting valve.

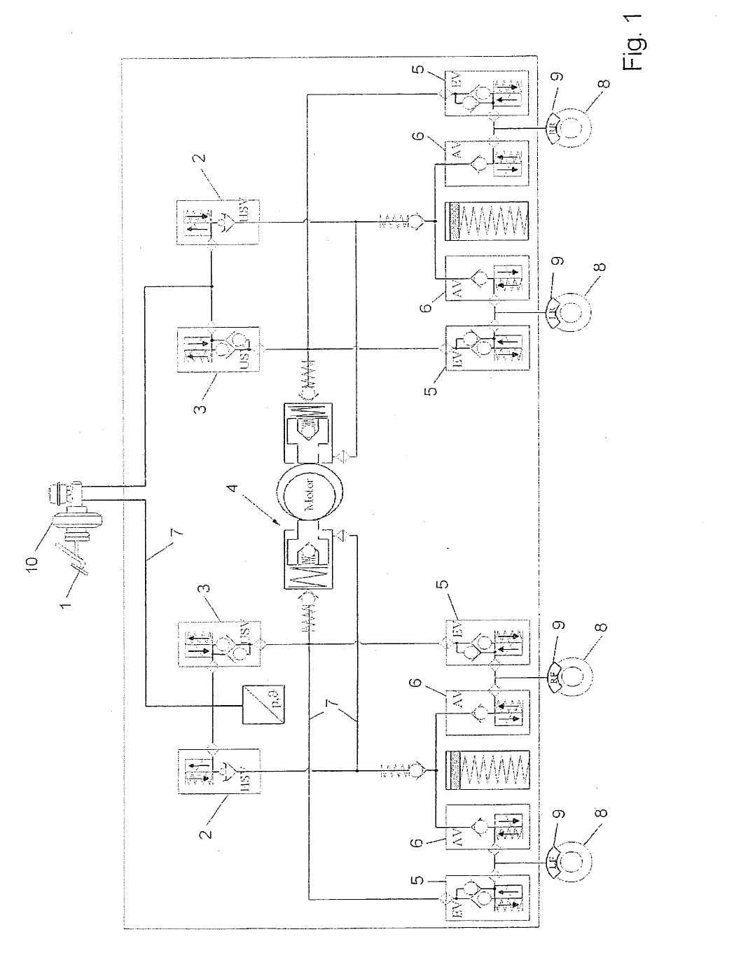

### DETAILED DESCRIPTION

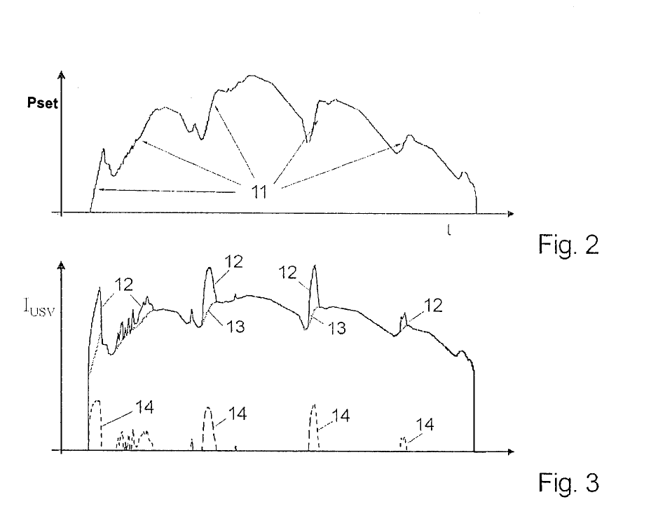

FIG. 2 shows the setpoint pressure curve in a braking system as it is preset by a TCS or ESP regulation, for example. Multiple dynamic pressure increases 11 having steep pressure buildup gradients may be seen in this case.

As noted, a pressure which is higher than the threshold value set at pressure-limiting valve 3 (this is typically the setpoint pressure preset by the regulation) may arise in the brake circuit in phases having high dynamic pressure buildup. Pressure-limiting valve 3 overflows during these pressure peaks and thus leads to a delay of the pressure buildup in wheel brakes 9.

In order to prevent undesired overflow of pressure-limiting valve 3, the threshold value at the pressure-limiting valve is increased as a function of the pressure buildup gradient. This is performed by appropriate setting of a current I_{USV} at pressure-limiting valve 3.

FIG. 3 shows current I_{USV} flowing through a magnetic coil of pressure-limiting valve 3 over time t. As may be seen in phases of high dynamic pressure increase 11, the current for setting the threshold value is increased in relation to that which would be set at quasi-stationary pressure (compare rises 12).

The current curve without an increase of the threshold value is identified by reference number 13.

The activation current is only increased in phases 11 in which the prevailing pressure buildup gradient exceeds a preset threshold value. Activation current I_{USV} flowing through pressure-limiting valve 3 is increased in these phases 11 in accordance with a stored characteristic curve and is thus higher during the pressure increase than in the event of identical pressures Pset in the quasi-static case (when the gradient is smaller than a preset threshold value).

The absolute increase of the activation current during the phases of high dynamic pressure increase 11 is identified by 14.

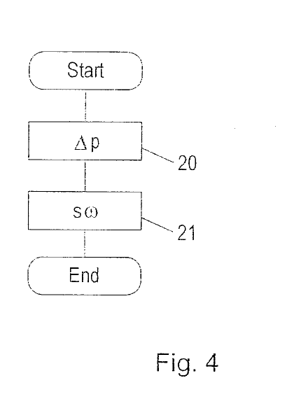

FIG. 4 once again shows the essential method steps during the increase of the setpoint pressure at pressure-limiting valve 3. In this case, the pressure buildup gradient is established in a first step 20 and the threshold value at pressure-limiting valve 3 is subsequently set in step 21 as a function of the pressure buildup gradient established, a higher threshold value being set for a higher pressure buildup gradient.

### LIST OF REFERENCE NUMBERS

| | |
|---|---|
| 1 | brake pedal |
| 2 | high-pressure-resistant switching valve |
| 3 | pressure-limiting valve |
| 4 | pressure generation element |
| 5 | intake valve |
| 6 | outlet valve |
| 7 | lines |
| 8 | wheels |
| 9 | brakes |
| 10 | brake master cylinder |
| 11 | regions having high pressure increase |
| 12 | current rises |
| 13 | current curve in the quasi-stationary case |
| 14 | absolute current rise |
| 20-21 | method steps |

What is claimed is:

1. A method of controlling a brake pressure acting on a wheel brake in a braking system that includes a pressure generation device for generating the brake pressure, an intake valve for admitting a brake fluid into the wheel brake, and a pressure-limiting valve for limiting the brake pressure to a selectable threshold value, the method comprising:
setting at the pressure-limiting valve the threshold value as a function of a pressure buildup gradient.

2. The method as recited in claim 1, wherein:
with an increasing pressure buildup gradient, the threshold value is set to a level that is comparatively higher than in the event of an identical setpoint pressure and a flatter pressure buildup gradient.

3. The method as recited in claim 1, wherein:
the threshold value is increased on the basis of one of a characteristic curve and a table stored in a system.

4. A braking system, comprising:
a pressure generation device for building up a brake pressure acting on a wheel brake;
an intake valve for admitting a brake fluid into the wheel brake; and
a pressure-limiting valve for limiting the brake pressure to a selectable threshold value, wherein:
the threshold value settable at the pressure-limiting valve is set as a function of a pressure buildup gradient.

5. The braking system as recited in claim 1, wherein:
the threshold value at the pressure-limiting valve is increased during one of a TCS regulation and an ESP regulation.
